(19) United States
(12) Patent Application Publication
(10) Pub. No.: US 2018/0264812 A1
(43) Pub. Date: Sep. 20, 2018

(54) LIQUID JETTING HEAD

(71) Applicant: BROTHER KOGYO KABUSHIKI KAISHA, Nagoya-shi (JP)

(72) Inventors: Kazunari MATSUURA, Komaki-shi (JP); Keita HIRAI, Nagoya-shi (JP)

(73) Assignee: BROTHER KOGYO KABUSHIKI KAISHA, Nagoya-shi (JP)

(21) Appl. No.: 15/912,753

(22) Filed: Mar. 6, 2018

(30) Foreign Application Priority Data
Mar. 15, 2017 (JP) 2017-049875

(51) Int. Cl. B41J 2/14; B41J 2/175; B41J 2/15

(52) U.S. Cl. CPC B41J 2/1404; B41J 2/17596; B41J 2/14201; B41J 2/15; B41J 2/14072

(57) ABSTRACT

A liquid jetting head includes: a channel substrate having a nozzle surface in which nozzles are open, the channel substrate being formed with pressure chambers communicating with the nozzles respectively; and an actuator covering the pressure chambers. The pressure chambers include first pressure chambers arranged in an arrangement direction to form a first pressure chamber row. The nozzles include first nozzles communicating with the pressure chambers respectively. Any two first nozzles that are adjacent in the arrangement direction are arranged at different positions in the channel substrate with respect to an orthogonal direction which is parallel to the nozzle surface and orthogonal to the arrangement direction and different in a first distance. The first distance is a distance in the orthogonal direction between each first nozzle and an end on one side in the orthogonal direction of the first pressure chamber communicating with the first nozzle.

### CROSS REFERENCE TO RELATED APPLICATION

The present application claims priority from Japanese Patent Application No. 2017-049875, filed on Mar. 15, 2017, the disclosure of which is incorporated herein by reference in its entirety.

### BACKGROUND

### Field of the Invention

The present invention relates to a liquid jetting head having a channel substrate in which at least one pressure-chamber row is formed.

### Description of the Related Art

A liquid jetting head having a channel substrate in which pressure chambers are formed has been known. In the channel substrate the pressure chambers form at least one pressure chamber row. Nozzles belonging to one pressure-chamber row are arranged in a nozzle plate to be shifted in an orthogonal direction, which is parallel to a nozzle surface and orthogonal to an arrangement direction of the pressure chambers. In other words, a position in the orthogonal direction of each nozzle differs from a position in the orthogonal direction of another nozzle which is adjacent in the arrangement direction.

### SUMMARY

However, when viewed from a direction orthogonal to the nozzle surface, these nozzles are positioned at substantial center in the orthogonal direction of the pressure chamber which communicates with that nozzle (in other words, a shift of the nozzle in the orthogonal direction is comparatively small). Therefore, an air curtain along the arrangement direction is susceptible to be formed by an air flow generated by jetting of liquid from each nozzle. In this case, an air flow in the orthogonal direction generated due to conveying of a paper runs against into the air curtain, and the air flow is perturbed. Therefore, a problem that the liquid jetted from each nozzle does not land at a desired position may arise.

An object of the present teaching is to provide a liquid jetting head in which the perturbation of air flow is hard to occur, and a problem that the liquid jetted from each nozzle does not land at a desired position is suppressed from arising.

According to an aspect of the present teaching, there is provided a liquid jetting head including: a channel substrate having a nozzle surface in which nozzles are open, the channel substrate being formed with pressure chambers communicating with the nozzles respectively; and an actuator covering the pressure chambers, wherein the pressure chambers include first pressure chambers arranged in an arrangement direction to form a first pressure chamber row in the channel substrate, each of the first pressure chambers has a first end on one side in an orthogonal direction and a second end on the other side in the orthogonal direction, the orthogonal direction being parallel to the nozzle surface and orthogonal to the arrangement direction, the nozzles include first nozzles communicating with the first pressure chambers respectively, any two first nozzles, which are included in the first nozzles and adjacent to each other in the arrangement direction, are arranged at different positions in the channel substrate with respect to the orthogonal direction and different in a first distance, the first distance being a distance in the orthogonal direction between each first nozzle and the first end of each first pressure chamber communicating with the first nozzle, the first nozzles include farthest two first nozzles that are separated from each other farthest with respect to the orthogonal direction, and a second distance in the orthogonal direction between the farthest two first nozzles is not less than a third distance, the third distance being a distance between each of the farthest two first nozzles and a nearest end of each first pressure chamber communicating with the first nozzle, the nearest end of the first pressure chamber being one of the first end and the second end which is nearer to the first nozzle in the orthogonal direction.

### BRIEF DESCRIPTION OF THE DRAWINGS

FIG. 1 is a schematic plan view of a printer provided with a head according to a first embodiment of the present teaching.

FIG. 2 is a cross-sectional view (a cross-sectional view along a line II-II in FIG. 3) depicting a portion of a channel formed in a channel substrate of the head.

FIG. 3 is a cross-sectional view along a line in FIG. 2.

FIG. 4 is a schematic diagram depicting a flow of ink from a tank in the head.

FIG. 5 is a cross-sectional view, of a head according to a modified embodiment of the first embodiment of the present teaching, corresponding to FIG. 2.

FIG. 6 is a cross-sectional view, of a head according a second embodiment of the present teaching, corresponding to FIG. 2.

FIG. 7 is a cross-sectional view, of a head according to a modified embodiment of the second embodiment of the present teaching, corresponding to FIG. 2.

FIG. 8 is a cross-sectional view, of a head according to a third embodiment of the present teaching, corresponding to FIG. 2.

FIG. 9 is a cross-sectional view, of a head according to a fourth embodiment of the present teaching, corresponding to FIG. 3.

FIG. 10 is a cross-sectional view, of a head according to another modified embodiment of the first embodiment of the present teaching, corresponding to FIG. 2.

### DESCRIPTION OF THE EMBODIMENTS

### First Embodiment

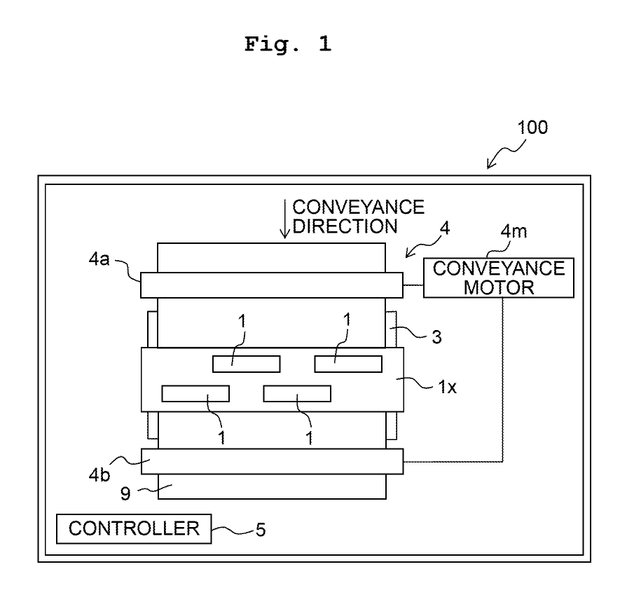

Firstly, an overall arrangement of a printer 100 will be described below by referring to FIG. 1. The printer 100 includes a head unit 1x, a platen 3, a conveyance mechanism 4, and a controller 5.

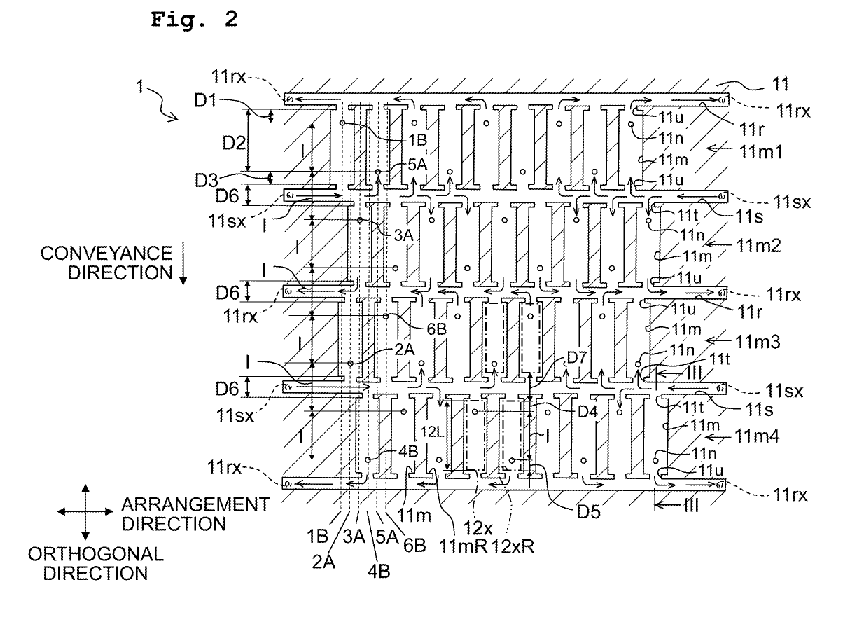

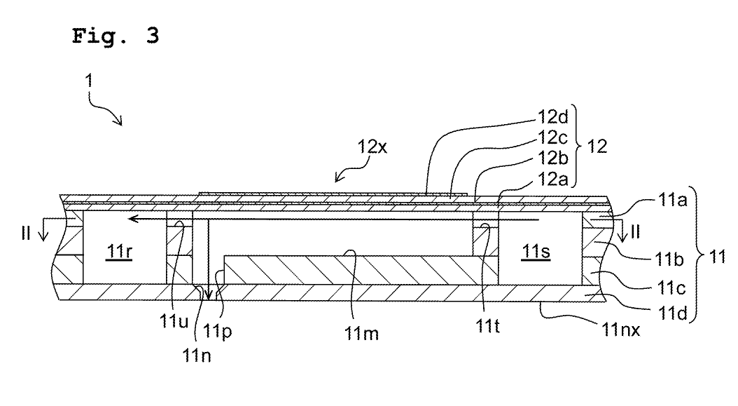

The head unit 1x is of a line type (in other words, a type in which an ink is jetted onto a paper 9 in a state that a position of the head unit 1x is fixed), and is long in a direction orthogonal to a conveyance direction of the paper 9. The head unit 1x includes four heads 1 according to a first embodiment of the present teaching. The four heads 1 are arranged in a zigzag form along the direction orthogonal to the conveyance direction. The four heads 1 have the same structure. Each head 1 jets ink from a plurality of nozzles 11n (refer to FIG. 2 and FIG. 3).

The platen 3 is arranged at a lower side of the head unit 1x. The ink is jetted from each head 1 onto a paper 9 supported by the platen 3.

The conveyance mechanism 4 includes two pairs of rollers 4a and 4b arranged to sandwich the platen 3 in the conveyance direction. As a conveyance motor 4m is driven, the two rollers in each of the pair of rollers 4a and 4b are rotated in mutually opposite directions in a state of pinching the paper 9. Accordingly, the paper 9 is conveyed in the conveyance direction.

The controller 5 controls the four heads 1, the conveyance motor 4m, and the like, such that an image is recorded on the paper 9 on the basis of a recording command that has been inputted from an external apparatus such as a PC (personal computer).

Next, an arrangement of the head 1 will be described below by referring to FIG. 2 to FIG. 4. The head 1 includes a channel substrate 11, an actuator 12, and a tank 14.

The channel substrate 11, as depicted in FIG. 3, includes four plates 11a, 11b, 11c, and 11d (hereinafter plates 11a to 11d), and the four plates 11a to 11d are adhered to one another. An upper portion of a pressure chamber 11m, an upper portion of a supply channel 11s, an upper portion of a return channel 11r, and throttles 11t and 11u are formed to penetrate the plate 11a. A lower portion of the pressure chamber 11m, a central portion in a vertical direction of the supply channel 11s, and a central portion in the vertical direction of the return channel 11r are formed to penetrate the plate 11b. A lower portion of the supply channel 11s, a lower portion of the return channel 11r, and a descender 11p which connects the pressure chamber 11m and the nozzle 11n are formed to penetrate the plate 11c. The nozzle 11n is formed to penetrate the plate 11d.

A lower surface of the channel substrate 11 (lower surface of the plate 11d) is a nozzle surface 11nx in which the plurality of nozzles 11n are open as depicted in FIG. 2 and FIG. 3. The nozzles 11n have the same shape and size.

Pressure chambers 11m are open in an upper surface of the channel substrate 11 (upper surface of the plate 11a) as depicted in FIG. 2 and FIG. 3. The pressure chambers 11m communicate with the nozzles 11n respectively. The plurality of pressure chambers 11m have the same shape and size.

The pressure chambers 11m are arranged to form four pressure-chamber rows 11m1, 11m2, 11m3, and 11m4 (hereinafter, pressure-chamber rows 11m1 to 11m4) as depicted in FIG. 2. The pressure chambers 11m in each of the pressure-chamber rows 11m1 to 11m4 are arranged at an equal distance in an arrangement direction (direction orthogonal to the conveyance direction). The four pressure-chamber rows 11m1 to 11m4 are arranged side-by-side in an orthogonal direction (direction orthogonal to the arrangement direction, and a direction parallel to the conveyance direction). The pressure chambers 11m forming each of the pressure-chamber rows 11m1 to 11m4 are formed at the same position in the orthogonal direction. The pressure chambers 11m are arranged in a zigzag form such that respective positions thereof in the arrangement direction differ.

Each of the supply channel 11s and the return channel 11r is extended in the arrangement direction as depicted in FIG. 2.

The supply channel 11s is provided one each between the pressure-chamber row 11m1 and the pressure-chamber row 11m2, and between the pressure-chamber row 11m3 and the pressure-chamber row 11m4. The return channel 11r is provided one each at an upstream side in the conveyance direction of the pressure-chamber row 11m1, between the pressure-chamber row 11m2 and the pressure-chamber row 11m3, and at a downstream side in the conveyance direction of the pressure-chamber row 11m4.

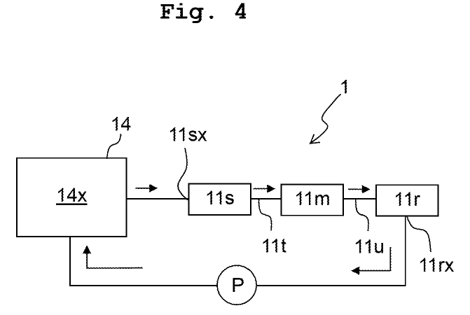

A supply port 11sx is formed at two ends of the arrangement direction of each supply channel 11s. A return port 11rx is formed at each of two ends in the arrangement direction of each return channel 11r. The supply ports 11sx and the return ports 11rx are open in a surface of the channel substrate 11. As depicted in FIG. 4, the supply channel 11s and the return channel 11r communicate with a storage chamber 14x of the tank 14 via a tube connected to the supply port 11sx and the return port 11rx respectively. Ink is stored in the storage chamber 14x. The ink in the storage chamber 14x inflows into the supply channel 11s via the supply port 11sx by a drive of a pump P, and is supplied to each pressure chamber 11m through a throttle 11t. Some of the ink supplied to each pressure chamber 11m is jetted from one of the nozzles 11n, and the remaining ink inflows into the return channel 11r through the throttle 11u, and is returned to the storage chamber 14x via the return port 11rx.

The supply channel 11s and the return channel 11r are arranged at the same height. The throttle 11t and the throttle 11u are arranged at the same height.

The supply channel 11s provided between the pressure-chamber row 11m1 and the pressure-chamber row 11m2 supplies ink to each pressure chamber 11m in these two pressure-chamber rows 11m1 and 11m2. The supply channel 11s provided between the pressure-chamber row 11m3 and the pressure-chamber row 11m4 supplies ink to each pressure chamber 11m in these two pressure chamber rows 11m3 and 11m4.

The return channel 11r provided to the upstream side of the conveyance direction of the pressure-chamber row 11m1 returns the ink to the storage chamber 14x from each pressure chamber 11m in the pressure-chamber rows 11m1. The return channel 11r provided between the pressure-chamber row 11m2 and the pressure-chamber row 11m3 returns the ink to the storage chamber 14x from each pressure chamber 11m in these two pressure-chamber rows 11m2 and 11m3. The return channel 11r provided to the downstream side in the conveyance direction of the pressure-chamber row 11m4 returns the ink to the storage chamber 14x from each pressure chamber 11m in the pressure-chamber row 11m4.

The actuator 12, as depicted in FIG. 3, is arranged on an upper surface of the channel substrate 11 to cover the plurality of pressure chambers 11m. The actuator 12 includes in order from a lower side, a vibration plate 12a, a common electrode 12b, a piezoelectric layer 12c, and a plurality of individual electrodes 12d. While the vibration plate 12a, the common electrode 12b, and the piezoelectric layer 12c are arranged to cover the plurality of pressure chambers 11m (in other words, to be spread over the plurality of pressure chambers 11m), the individual electrodes 12d are arranged to face the pressure chambers 11m respectively. The common electrode 12b is grounded.

A portion of the piezoelectric layer 12c sandwiched between the individual electrode 12d and the common electrode 12b functions as an active portion 12x which is deformable according to a voltage applied to the individual electrode 12d. In other words, the actuator 12 includes active portions 12x facing the pressure chambers 11m respectively, in a direction orthogonal to the nozzle surface 11nx (refer to FIG. 2). By driving the active portion 12x (in other words, by deforming (such that the active portion 12x forms a projection toward the pressure chamber 11m) the active portion 12x according to the voltage applied to the individual electrode 12d), volume of the pressure chamber 11m changes. At this time, pressure is applied to the ink in the pressure chamber 11m, and the ink is jetted from the nozzle 11n.

Next, an arrangement of the nozzles 11n will be described in detail by referring to FIG. 2.

Each nozzle 11n is arranged in an area of the pressure chamber 11m (a pressure chamber area 11mR) communicating with the nozzle 11n, and in an area of the active portion 12x (an active portion area 12xR) facing the pressure chamber 11m which communicates with the nozzle 11n. The pressure chamber area 11mR is an area formed by projecting the pressure chamber 11m on the nozzle surface 11nx, from the direction orthogonal to the nozzle surface 11nx. The active portion area 12xR is an area formed by projecting the active portion 12xR on the nozzle surface 11nx, from the direction orthogonal to the nozzle surface 11nx.

Among the nozzles 11n belonging to each of the pressure chamber rows 11m1 to 11m4 (in other words, communicating with the pressure chambers 11m forming each of the pressure chamber rows 11m1 to 11m4), any two nozzles 11m adjacent in the arrangement direction are different in a distance in an orthogonal direction from one end in the orthogonal direction of the pressure chamber 11m communicating with the nozzle 11n, and are arranged at different positions with respect to the orthogonal direction. As depicted in FIG. 2, with respect to the first nozzle 11n and the second nozzle 11n from left in the pressure chamber row 11m1, a distance D1 in the orthogonal direction from one end (upper end in FIG. 2) of the pressure chamber 11m communicating with the first nozzle 11n differs from a distance D2 in the orthogonal direction from one end of the pressure chamber 11m communicating with the second nozzle 11n. Moreover, a position in the orthogonal direction of the first nozzle 11n differs from a position in the orthogonal direction of the second nozzle 11n.

Among the nozzles 11n belonging to each of the pressure chamber rows 11m1 to 11m4, a position in the orthogonal direction of each nozzle 11n, excluding nozzles 11n positioned at both ends in the arrangement direction, is different from a position in the orthogonal direction of each of nozzles 11n adjacent on both sides in the arrangement direction of the nozzle 11n. In the present embodiment, a position in the orthogonal direction of the nozzles 11n belonging to each of the pressure chamber rows 11m1 to 11m4 differs for each in the arrangement direction, and is the same for alternate nozzles in the arrangement direction. In other words, the nozzles 11n belonging to each of the pressure chamber rows 11m1 to 11m4 form two nozzle rows arranged in the orthogonal direction. Each nozzle row includes a plurality of nozzles 11n arranged in the arrangement direction.

The four pressure chamber rows 11m1 to 11m4 have the same distance I between two nozzles. The distance I between two nozzles is a distance in the orthogonal direction between two most separated (two mutually farthest) nozzles 11n in the orthogonal direction (in the present embodiment, two mutually adjacent nozzles 11n in the arrangement direction).

The distance I between the two nozzles is not less than the shortest distance between these two nozzles 11n. The shortest distance is a distance in the orthogonal direction between each of these two nozzles 11n and the nearest end of the one pressure chamber 11m communicating with the nozzle 11n. The nearest end is an end portion nearer to the nozzle 11n out of the two end portions in the orthogonal direction of the pressure chamber 11m. For example, in FIG. 2, a shortest distance D1 of the first nozzle 11n from left of the pressure chamber row 11m1 is a distance between the nozzle 11n and the nearest end (an upper end in FIG. 2) of the one pressure chamber 11m communicating with the nozzle 11n. Similarly, a shortest distance D3 of the second nozzle 11n from left of the pressure chamber row 11m1 is a distance between the nozzle 11n and the nearest end (a lower end in FIG. 2) of the pressure chamber 11m communicating with that nozzle 11n. The distance I between the first nozzle 11n from left in the pressure chamber row 11m1 and the second nozzle 11n from left in the pressure chamber row 11m1 is not less than the shortest distance D1 of the first nozzle 11n from left, and is also not less than the shortest distance D3 of the second nozzle 11n from left.

In the present embodiment, the shortest distance D1 and the shortest distance D3 are equal. Moreover, for all the pressure chamber rows 11m1 to 11m4, the two most separated nozzles 11n in the orthogonal direction have the same distance in the orthogonal direction from the nozzle 11n up to an end portion, of the pressure chamber 11m communicating with the nozzle 11n, which is nearer to the nozzle 11n in the orthogonal direction out of the two ends in the orthogonal direction. In other words, for all the pressure chambers 11m of the head 1, a relative positional relationship of the pressure chamber 11m and the nozzle 11n is the same. Accordingly, it is possible to suppress a problem of unevenness in jetting characteristics (such as a size of ink droplets jetted from the nozzle 11n, a jetting speed (velocity), and a jetting direction).

Moreover, the distance I is a distance in the orthogonal direction from the nozzle 11n up to an end portion nearer to the nozzle 11n in the orthogonal direction out of two ends in the orthogonal direction of the active portion 12x facing the pressure chamber 11m communicating with the nozzle 11n, in each of the two nozzles 11n. Specifically, in FIG. 2, when a fourth and a fifth nozzles 11n from left of the pressure chamber row 11m4 are targeted, the distance I is not less than a distance D4 in the orthogonal direction, from the fourth nozzle 11n from left in the pressure chamber row 11m4 up to the end portion (an upper end in FIG. 2) nearer to the nozzle 11n in the orthogonal direction out of the two ends in the orthogonal direction of the active portion 12x facing the pressure chamber 11m communicating with the nozzle 11n, and is not less than a distance D5 in the orthogonal direction, from the fifth nozzle 11n from left in the pressure chamber row 11m4 up to an end portion (a lower end in FIG. 2) nearer to the nozzle 11n in the orthogonal direction out of the two ends in the orthogonal direction of the active portion 12x facing the pressure chamber 11m communicating with the nozzle 11n.

Furthermore, the distance I is not less than a distance D6 in the orthogonal direction between the pressure chambers 11m in the pressure chamber row to which these two nozzles 11n belong and the pressure chambers 11m in another pressure chamber row which is adjacent to the pressure chamber row in the orthogonal direction. The four pressure chamber rows 11m1 to 11m4 are arranged at the equal distance D6 in the orthogonal direction. In other words, the distance D6 in the orthogonal direction between the pressure chambers 11m forming the pressure chamber row 11m1 and the pressure chambers 11m forming the pressure chamber row 11m2, the distance D6 in the orthogonal direction between the pressure chambers 11m in the pressure chamber row 11m2 and the pressure chambers 11m forming the pressure chamber row 11m3, the distance D6 in the orthogonal direction between the pressure chambers 11m forming the pressure chamber row 11m3 and the pressure chambers 11m forming the pressure chamber row 11m4 are the same.

The distance D6 is smaller than a length 12L in the orthogonal direction of each active portion 12x.

The distance I is not less than a distance D7 between the active portions 12x belonging to the pressure chamber row to which these two nozzles 11n belong and the active portions 12x belonging to another pressure chamber row which is adjacent in the orthogonal direction to the pressure chamber row. The active portions 12x, similar to the pressure chambers 11m, are also arranged at the same distance D7 in the orthogonal direction.

The distance I is equal to the minimum distance in the orthogonal direction from the nozzles 11n belonging to the one pressure chamber row up to the nozzles 11n belonging to another pressure chamber row which is adjacent in the orthogonal direction to the pressure chamber row. In other words, the nozzles 11n belonging to all the pressure chamber rows 11m1 to 11m4 is arranged at the equal distance (distance I) in the orthogonal direction.

Moreover, the distance I is an even multiple of a distance corresponding to the maximum resolution in the orthogonal direction. Specifically, in the present embodiment, the maximum resolution in the orthogonal direction is 1200 dpi (dots per inch), and the distance corresponding to the maximum resolution in the orthogonal direction is 42 μm. Therefore, the distance I is an even multiple of 42 μm (such as 42 μm×2=84 μm and 42 μm×4=168 μm).

Furthermore, when there is a plurality of patterns of a distance in the orthogonal direction from the supply channel 11s that supplies an ink to the pressure chamber 11m communicating with the nozzle 11n, of the plurality of nozzles 11n corresponding to the plurality of dots lined up in the arrangement direction, the plurality of nozzles 11n is arranged in a pattern in which the frequency of consecutive nozzles 11n with the equal distance in the orthogonal direction from the supply channel 11s, is the minimum. Specifically, in FIG. 2, numbers “1” to “6” are assigned in order from left, to the plurality of nozzles 11n corresponding to a plurality of dots lined up in the arrangement direction, and a nozzle 11n for which the distance in the orthogonal direction from the supply channel 11s is comparatively small is let to be “A” and a nozzle 11n for which the distance in the orthogonal direction from the supply channel is longer than for “A” is let to be “B” (in the present embodiment, since the nozzles 11n belonging to each pressure chamber row form two nozzle rows, the nozzles are classified into two which are “A” and “B”. In the present embodiment, the nozzles 11n from “1” to “6” are “B”, “A”, “A”, “B”, “A”, and “B”.

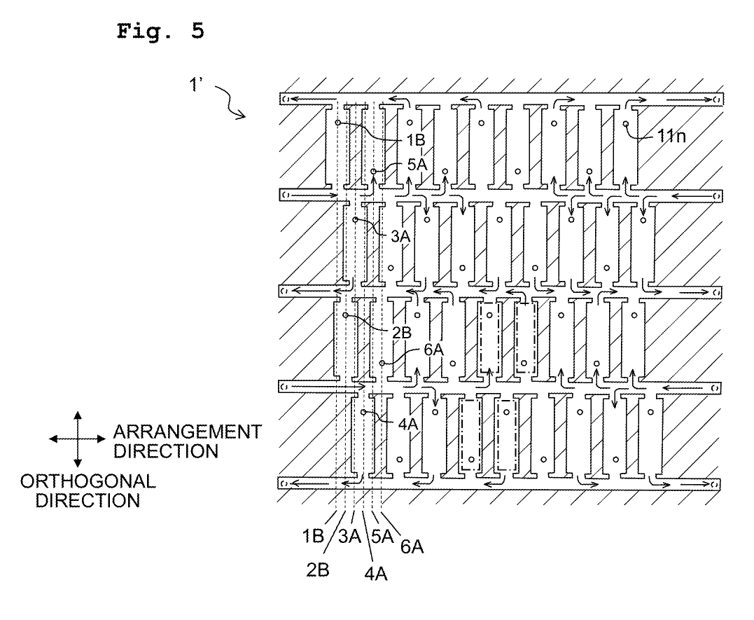

On the other hand, in a head 1′ according to a modified embodiment in FIG. 5, numbers “1” to “6” are assigned in order from left to the plurality of nozzles 11n corresponding to the plurality of dots lined up in the arrangement direction, and when the nozzles 11n are classified similarly as mentioned above, the nozzles 11n from “1” to “6” are “B”, “B”, “A”, “A”, “A”, and “A”. In other words, in the modified embodiment in FIG. 5, the number of consecutive nozzles 11n with the equal distance in the orthogonal direction from the supply channel 11s is large as “A”, “A”, “B”, “B” compared to the frequency of consecutive nozzles 11n in the present embodiment.

In a case in which the nozzles 11n belonging to each pressure chamber row form two nozzle rows, there are various patterns of arrangement of the nozzles 11n including the pattern in the modified embodiment in FIG. 5. In the present embodiment, of the various patterns, a pattern in which the frequency of the consecutive nozzles 11n with the equal distance in the orthogonal direction from the supply channel 11s is the minimum, which is also a pattern in which the nozzles 11n with the equal distance in the orthogonal direction from the supply channel 11s are not consecutive for not less than 84 has been adopted.

As described above, according to the present embodiment, the plurality of nozzles 11n belonging to the pressure chamber rows 11m1 to 11m4 are arranged such that the distance in the orthogonal direction from one end in the orthogonal direction of the pressure chamber 11m communicating with the nozzle 11n differs mutually from the distance for another nozzle which is adjacent in the arrangement direction (for example, D1≠D2 in FIG. 2), and the position in the orthogonal direction differs mutually from the position of another nozzle 11n. Moreover, the distance I in the orthogonal direction between the two nozzles 11n most separated mutually in the orthogonal direction, out of the plurality of nozzles 11n belonging to the pressure chamber rows 11m1 to 11m4 is not less than the distance (for example D1 and D3 in FIG. 2) from the nozzle 11n up to the end portion near the nozzle 11n in the orthogonal direction out of the two ends in the orthogonal direction of the one pressure chamber 11m communicating with the nozzles 11n, for each of the two nozzles 11n. In other words, the plurality of nozzles 11n belonging to the pressure chamber rows 11m1 to 11m4 is arranged to be shifted in the orthogonal direction, and the shift of the nozzles 11n in the orthogonal direction is comparatively large. Therefore, an air curtain along the arrangement direction is hard to be formed, and an air flow in the orthogonal direction, which is generated due to the conveyance of the paper 9, can pass easily between the nozzles 11n adjacent in the arrangement direction. Accordingly, the air flow is hardly perturbed, and it is possible to suppress a problem of the ink jetted from each nozzle 11n not landing at a desired position.

Positions in the orthogonal direction of the plurality of pressure chambers 11m forming the pressure chamber rows 11m1 to 11m4 are same. When the plurality of pressure chambers 11m forming the pressure chamber rows 11m1 to 11m4 is lined up to be shifted, a size of the channel substrate 11 in the orthogonal direction becomes large. Whereas, since the positions in the orthogonal direction of the plurality of pressure chambers 11m forming the pressure chamber rows 11m1 to 11m4 are aligned, it is possible to make the perturbation of the air flow hard to occur by the arrangement of the nozzles 11n, while avoiding the size of the channel substrate 11 in the orthogonal direction becoming large.

The nozzles 11n are arranged in the pressure chamber area 11mR. Accordingly, it is possible to carry out the jetting of ink efficiently from each nozzle 11n.

The distance I is not less than the distance (for example, the distance D4 and D5 in FIG. 2) in the orthogonal direction from the nozzle 11n up to the end portion near the nozzle 11n in the orthogonal direction out of the two ends in the orthogonal direction of the active portion 12x facing the pressure chamber 11m communicating with the nozzle 11n. Accordingly, it is possible to make large assuredly, the shift in the orthogonal direction of the plurality of nozzles 11n belonging to the pressure chamber rows 11m1 to 11m4.

The nozzles 11n are arranged in the active portion area 12xR. Accordingly, it is possible to carry out the jetting of ink efficiently from each nozzle 11n.

The position in the orthogonal direction of the nozzle other than the nozzles positioned at ends in the arrangement direction, out of the plurality of nozzles 11n belonging to each of the pressure chamber rows 11m1 to 11m4, differs from the positions of the nozzles adjacent on both sides in the arrangement direction. Therefore, the air curtain along the arrangement direction is even harder to be formed, and the air flow in the orthogonal direction which is generated due to the conveyance of the paper 9 can pass easily between the nozzles 11n adjacent in the arrangement direction. Accordingly, the air flow is hardly perturbed, and it is possible to suppress more assuredly, the problem of the ink jetted from each nozzle 11n not landing at a desired position.

The distance I is equal to the minimum distance in the orthogonal direction from the plurality of nozzles 11n belonging to the one pressure chamber row up to the plurality of nozzles 11n belonging to another pressure chamber row which is adjacent to the pressure chamber row in the orthogonal direction. By letting the distance I to be not less than the minimum distance, it is possible to make large assuredly, the shift in the orthogonal direction of the plurality of nozzles 11n belonging to the pressure chamber rows 11m1 to 11m4. Furthermore, in the present embodiment, the distance I being equal to the minimum distance, the nozzles 11n are arranged at an equal distance in the orthogonal direction, in the two pressure chamber rows that are mutually adjacent in the orthogonal direction. Therefore, the air curtain along the arrangement direction is even harder to be formed, and the air flow in the orthogonal direction which is generated due to the conveyance of the paper P can pass easily between the nozzles 11n adjacent in the arrangement direction. Accordingly, the air flow is hardly perturbed, and it is possible to suppress more assuredly, the problem of the ink jetted from each nozzle 11n not landing at a desired position.

The nozzles 11n belonging to all the four pressure chamber rows 11m1 to 11m4 are arranged at an equal distance (distance I) in the orthogonal direction. Accordingly, the perturbation of the air flow is hardly caused, and it is possible to suppress more assuredly, the problem of the ink jetted from each nozzle 11n not landing at a desired positon.

The distance I is not less than the distance D6 in the orthogonal direction between the pressure chambers 11m forming the pressure chamber row to which these two nozzles 11n belong and the pressure chambers 11m forming another pressure chamber row adjacent in the orthogonal direction to the pressure chamber row. Accordingly, it is possible to make large even more assuredly, the shift in the orthogonal direction of the nozzles 11n belonging to each of the pressure chamber rows 11m1 to 11m4.

The distance I is not less than the distance D7 in the orthogonal direction between the plurality of active portions 12x belonging to the pressure chamber row to which these two nozzles 11n belong and the plurality of active portions 12x belonging to another pressure chamber row which is adjacent in the orthogonal direction to the pressure chamber row. Accordingly, it is possible to make large even more assuredly, the shift in the orthogonal direction of the plurality of nozzles 11n belonging to each of pressure chamber rows 11m1 to 11m4.

The distance D6 is smaller than the length 12L in the orthogonal direction of the one active portion 12x. Therefore, it is possible to arrange the pressure chamber rows 11m1 to 11m4 at a small distance, and the pressure chambers 11m highly densely.

The supply channel 11s and the return channel 11r are formed in the channel substrate 11. Therefore, it is possible to circulate the ink between the storage chamber 14x and each pressure chamber 11m. Accordingly, it is possible to eliminate an air bubble in the ink. Moreover, an increase in viscosity of the ink is prevented.

When there is a plurality of patterns of the distance in the orthogonal direction from the supply channel 11s that supplies an ink to the pressure chamber 11m communicating with the nozzle 11n, of the plurality of nozzles corresponding to the plurality of dots arranged in the arrangement direction, the plurality of nozzles 11n is arranged in the pattern in which the frequency of consecutive nozzles 11n with the equal distance in the orthogonal direction from the supply channel 11s, is the minimum (For example, the nozzles 11n from “1” to “6” are arranged in a pattern of “B”, “A”, “A”, “B”, “A”, and “B”). The jetting characteristics may change according to the distance in the orthogonal direction from the supply channel 11s. Therefore, when the frequency of consecutive nozzles 11n with the equal distance in the orthogonal direction from the supply channel 11s is large, a difference in characteristics becomes remarkable, and an image quality is deteriorated due to occurrence of lines (stripes) in an image. Regarding this point, it is possible to reduce the problem by the arrangement described above.

The plurality of nozzles 11n corresponding to the plurality of dots lined up in the arrangement direction is arranged in the pattern in which the nozzles 11n with the equal distance in the orthogonal direction from the supply channel 11s are not consecutive for 84 μm or more. When the nozzles 11n with the equal distance in the orthogonal direction from the supply channel 11s are consecutive for not less than 84 μm, the difference in characteristics is easily visible to a person. With regard to this point, it is possible to reduce the problem by the arrangement described above.

The distance I is an even multiple of the distance corresponding to the maximum resolution in the orthogonal direction. Accordingly, it is easy to deal with a degradation of resolution in the orthogonal direction due to a change in a printing mode.

### Second Embodiment

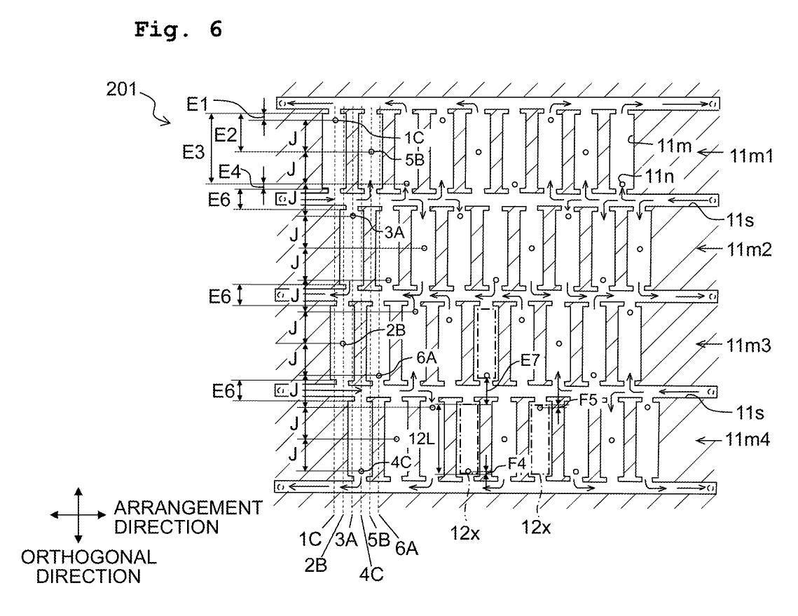

Next, a head 201 according to a second embodiment of the present teaching will be described below by referring to FIG. 6. In the head 201, the plurality of nozzles 11n belonging to each of the pressure chamber rows 11m1 to 11m4 are lined up in the arrangement direction, and form three nozzle rows arranged side-by-side in the orthogonal direction. As the number of nozzle rows to which the plurality of nozzles 11n belongs becomes larger, the air curtain along the arrangement direction is hard to be formed, and the air flow in the orthogonal direction which is generated due to the conveyance of the paper 9 can pass easily between the nozzles 11n adjacent in the arrangement direction.

The plurality of nozzles 11n belonging to the each of the pressure chamber rows 11m1 to 11m4 are arranged such that, a distance in the orthogonal direction from one end in the orthogonal direction of the pressure chamber 11m communicating with the nozzle 11n mutually differs from the distance for another nozzle 11n adjacent in the arrangement direction, and the position in the orthogonal direction mutually differs from a position for the another nozzle 11n. For example, as depicted in FIG. 6, a distance E1 in the orthogonal direction from one end (upper end in FIG. 6) of the pressure chamber 11m communicating with that nozzle 11n in the first nozzle 11n from left in the pressure chamber row 11m1 differs from a distance E2 in the orthogonal direction from one end of the pressure chamber 11m communicating with the nozzle 11n in the second nozzle (another nozzle adjacent in the arrangement direction to the first nozzle from left) 11n from left in the pressure chamber row 11m1. Furthermore, the distance E2 differs from a distance E3 in the orthogonal direction from one end of the pressure chamber 11m communicating with the nozzle 11n in the third nozzle (another nozzle adjacent in the arrangement direction to the second nozzle from left) 11n from left in the pressure chamber row 11m1. Moreover, a position in the orthogonal direction of the first nozzle 11n from left in the pressure chamber row 11m1 differs from a position in the orthogonal direction of the second nozzle 11n from left in the pressure chamber row 11m1. The position in the orthogonal direction of the second nozzle 11n from left in the pressure chamber row 11m1 differs from a position in the orthogonal direction of the third nozzle 11n from left in the pressure chamber row 11m1.

A position of a nozzle other than nozzles positioned at ends in the arrangement direction, out of the plurality of nozzles 11n belonging to each of the pressure chamber rows 11m1 to 11m4, differs from a position of a nozzle adjacent on both sides in the arrangement direction. In the present embodiment, the plurality of nozzles 11n belonging to each of the pressure chamber rows 11m1 to 11m4 is arranged such that a position in the orthogonal direction of each differs, and position in the orthogonal direction of alternate nozzles are same. In other words, the plurality of nozzles 11n belonging to each of the pressure chamber rows 11m1 to 11m4 form three nozzle rows side-by-side in the orthogonal direction, each nozzle row arranged in the arrangement direction.

A distance 2J (=J×2) in the orthogonal direction between two most separated nozzles 11n in the orthogonal direction (in the present embodiment, two nozzles 11n arranged sandwiching one nozzle 11n in the arrangement direction) is equal in the four pressure chamber rows 11m1 to 11m4.

The distance 2J is not less than a distance in the orthogonal direction from the nozzle 11n up to an end portion near the nozzle 11n in the orthogonal direction out of two ends in the orthogonal direction of one pressure chamber 11m communicating with the nozzle 11n, in each of these two nozzles 11n. For example, as depicted in FIG. 6, the distance 2J in the orthogonal direction between the first and the third nozzles 11n from left of the pressure chamber row 11m1 is not less than the distance E1 in the orthogonal direction, from the first nozzle 11n from left in the pressure chamber row 11m1 up to the end portion (upper end in FIG. 6) near the nozzle 11n in the orthogonal direction, out of the two ends in the orthogonal direction of the one pressure chamber 11m communicating with the nozzle 11n, and is not less than a distance E4 in the orthogonal direction from the third nozzle 11n from left in the pressure chamber row 11m1 up to an end portion (a lower end in FIG. 6) near the nozzle 11n in the orthogonal direction out of the two ends in the orthogonal direction of the one pressure chamber 11m communicating with the nozzle 11n.

In the present embodiment, the distance E1 and the distance E4 are equal. Moreover, similarly as in the first embodiment, a distance in the orthogonal direction from the nozzle 11n in the two mutually most separated nozzles 2n in the orthogonal direction out of the plurality of nozzles 11n belonging to each of the pressure chamber rows 11m1 to 11m4, up to an end portion near the nozzle 11n in the orthogonal direction, out of the two ends in the orthogonal direction of the one pressure chamber 11m communicating with the nozzle 11n is equal for all nozzles. In other words, for all the pressure chambers 11m of the head 1, a relative positional relationship of the pressure chamber 11m and the nozzle 11n is equal (same). Accordingly, it is possible to suppress a problem of unevenness in jetting characteristics.

Moreover, the distance 2J is a distance in the orthogonal direction from the nozzle 11n up to an end portion near the nozzle 11n in the orthogonal direction out of two ends in the orthogonal direction of the active portion 12x facing the pressure chamber 11m communicating with the nozzle 11n, in each of the two nozzles 11n. For example, as depicted in FIG. 6, the distance 2J in the orthogonal direction between the fourth and the fifth nozzles 11n from left of the pressure chamber 11m4 is not less than a distance F4 in the orthogonal direction, from the fourth nozzle 11n from left in the pressure chamber row 11m4 up to the end portion (a lower end in FIG. 6) near the nozzle 11n in the orthogonal direction out of the two ends in the orthogonal direction of the active portion 12x facing the pressure chamber 11m communicating with the nozzle 11n, and is not less than a distance F5 in the orthogonal direction, from the sixth nozzle 11n from left in the pressure chamber row 11m4 up to an end portion (an upper end in FIG. 6) near the nozzle 11n in the orthogonal direction out of the two ends in the orthogonal direction of the active portion 12x facing the pressure chamber 11m communicating with the nozzle 11n.

A distance J in the orthogonal direction from one nozzle 11n up to another nozzle 11n adjacent in the arrangement direction (a distance in the orthogonal direction between the nozzles 11n that are mutually adjacent in the arrangement direction) is not less than a distance E6 in the orthogonal direction between the plurality of pressure chambers 11m which forms the pressure chamber row to which these two nozzles belong, and the plurality of pressure chambers 11m which forms another pressure chamber row adjacent in the orthogonal direction to the pressure chamber row. The four pressure chamber rows 11m1 to 11m4 are arranged at the equal distance E6 in the orthogonal direction. In other words, the distance E6 in the orthogonal direction between the plurality of pressure chambers 11m forming the pressure chamber row 11m1 and the plurality of pressure chambers 11m forming the pressure chamber row 11m2, the distance E6 in the orthogonal direction between the plurality of pressure chambers 11m forming the pressure chamber row 11m2 and the plurality of pressure chambers 11m forming the pressure chamber row 11m3, and the distance E6 in the orthogonal direction between the plurality of pressure chambers 11m forming the pressure chamber row 11m3 and the plurality of pressure chambers 11m forming the pressure chamber row 11m4 are mutually same.

The distance E6 is smaller than the length 12L in the orthogonal direction of the one active portion 12x.

The distance J is not less than a distance E7 between the plurality of active portions 12x belonging to the pressure chamber row to which these two nozzles 11n belong and the plurality of active portions 12x belonging to another pressure chamber row which is adjacent in the orthogonal direction to the abovementioned pressure chamber row. The active portions 12x, similar to the pressure chambers 11m, are also arranged at the equal distance E7 in the orthogonal direction.

Moreover, the distance J is equal to the minimum distance in the orthogonal direction from the plurality of nozzles 11n belonging to the one pressure chamber row up to the plurality of nozzles 11n belonging to another pressure chamber row which is adjacent in the orthogonal direction to the abovementioned pressure chamber row. In other words, the plurality of nozzles belonging to all the pressure chamber rows 11m1 to 11m4 is arranged at the same distance J in the orthogonal direction. Accordingly, the air flow is even harder to be perturbed, and it is possible to suppress even more assuredly, the problem of the ink jetted from each nozzle 11n not landing at a desired position.

The distance J is an even multiple of a distance corresponding to the maximum resolution in the orthogonal direction.

Furthermore, when there is a plurality of patterns of a distance in the orthogonal direction from the supply channel 11s that supplies an ink to the pressure chamber 11m communicating with the nozzle 11n, of the plurality of nozzles 11n corresponding to the plurality of dots lined up in the arrangement direction, the plurality of nozzles 11n is arranged in a pattern in which the frequency of consecutive nozzles 11n with the equal distance in the orthogonal direction from the supply channel 11s, is the minimum. Specifically, in FIG. 6, numbers “1” to “6” are assigned in order from left, to the plurality of nozzles 11n corresponding to a plurality of dots lined up in the arrangement direction, and a nozzle 11n for which the distance in the orthogonal direction from the supply channel 11s is the minimum is let to be “A”, a nozzle 11n for which the distance is longer than for “A” is let to be “B”, and a nozzle 11n for which the distance is longer than for “B” is let to be “C” (in the present embodiment, since the nozzles 11n belonging to each pressure chamber row form three nozzle rows, the nozzles are classified into three which are “A”, “B”, and “C”). In the present embodiment, the nozzles 11n from “1” to “6” are “C”, “B”, “A”, “C”, “B”, and “A”.

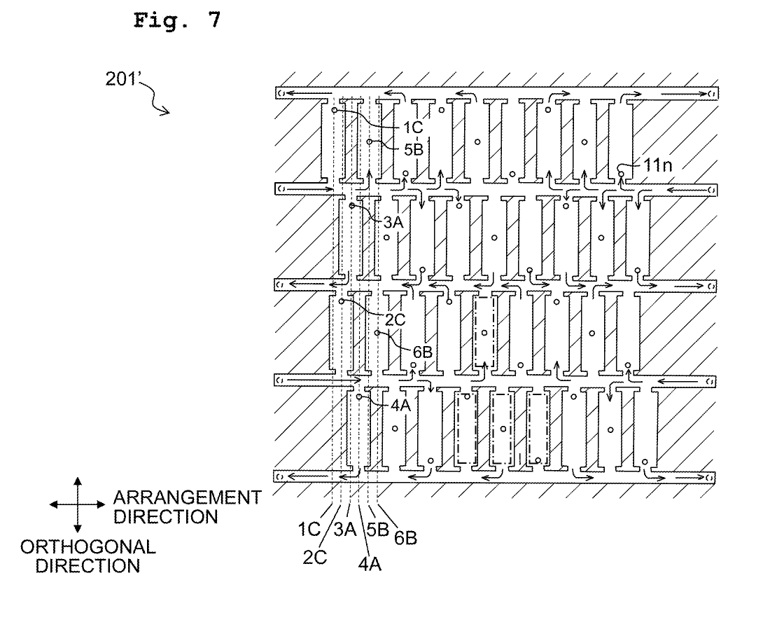

On the other hand, in a head 201′ according to a modified embodiment in FIG. 7, numbers “1” to “6” are assigned in order from left to the plurality of nozzles 11n corresponding to the plurality of dots lined up in the arrangement direction, and when the nozzles are classified similarly as “A”, “B”, and “C” mentioned above, the nozzles 11n from “1” to “6” are “C”, “C”, “A”, “A”, “B”, and “B”. In other words, in the modified embodiment in FIG. 7, the frequency of consecutive nozzles 11n with the equal distance in the orthogonal direction from the supply channel 11s is larger as “A” “A”, “B” “B”, and “C” “C” compared to the frequency of consecutive nozzles 11n in the present embodiment.

In a case in which the nozzles 11n belonging to each pressure chamber row form three nozzle rows, there are various patterns of arrangement of the nozzles 11n including the pattern in the modified embodiment in FIG. 7. In the present embodiment, a pattern in which the nozzles 11n with the equal distance in the orthogonal direction from the supply channel 11s are not consecutive (continuous) has been adopted.

According to the present embodiment, it is possible to achieve the following effect apart from the similar effect achieved by an arrangement similar as in the first embodiment.

The plurality of nozzles 11n corresponding to the plurality of dots lined up in the arrangement direction is arranged in the pattern in which the nozzles 11n with the equal distance in the orthogonal direction from the supply channel 11s are not consecutive. Accordingly, the difference in characteristics is even more remarkable.

### Third Embodiment

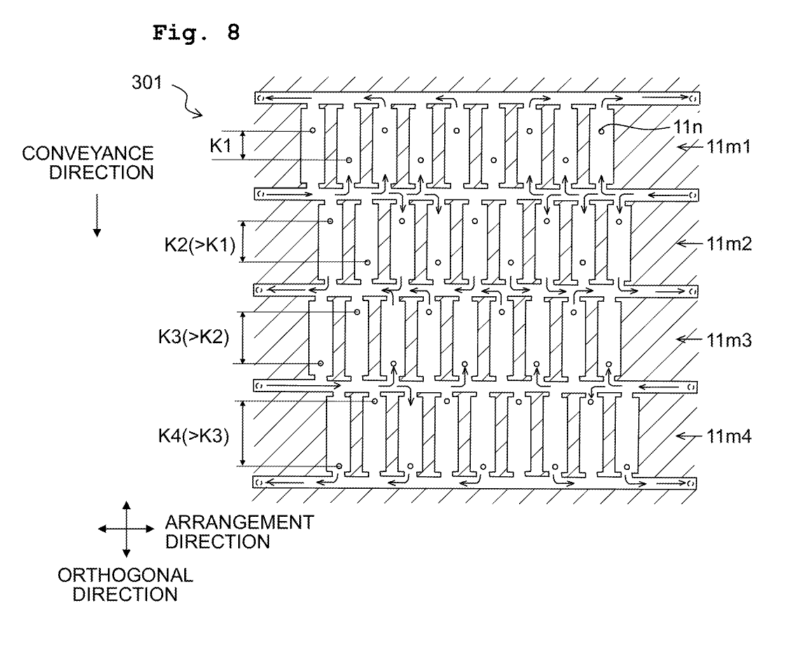

Next, for a head 301 according to a third embodiment of the present teaching, points that differ from the head 1 according to the first embodiment will be described below by referring to FIG. 8. The head 301 differs from the head 1 at a point that the distance in the orthogonal direction between the plurality of nozzles 11n belonging to the pressure chamber rows 11m1 to 11m4 differs for each of the pressure chamber rows 11m1 to 11m4.

Distances K1, K2, K3, and K4 (hereinafter, distances K1 to K4) in the orthogonal direction between the two nozzles 11n (in the present embodiment, the two nozzles 11n that are mutually adjacent in the arrangement direction) out of the plurality of nozzles 11n belonging to each of the pressure chamber rows 11m1 to 11m4 differ mutually in the four pressure chamber rows 11m1 to 11m4. Specifically, the more (farther) on a downstream side of the conveyance direction the pressure chamber row out of the four pressure chamber rows 11m1 to 11m4 is, longer is the distance in the orthogonal direction from the one nozzle 11n in the plurality of nozzles 11n belonging to that pressure chamber row up to another nozzle 11n which is adjacent in the arrangement direction. In other words, the distance K4 in the pressure chamber row 11m4 is longer than the distance K3 in the pressure chamber row 11m3, the distance K3 is longer than the distance K2 in the pressure chamber row 11m2, and the distance K2 is longer than the distance K1 in the pressure chamber row 11m1.

According to the present embodiment, it is possible to achieve the following effect apart from the similar effect achieved by an arrangement similar as in the first embodiment.

The more (farther) on the downstream side of the conveyance direction, the perturbation of the air flow is susceptible to become substantial. With regard to this point, according to the present embodiment, the more the pressure chamber row is on the downstream side of the conveyance direction, longer is the distance in the orthogonal direction from the one nozzle 11n in the plurality of nozzles 11n belonging to that pressure chamber row up to another nozzles 11n adjacent in the arrangement direction (K4>K3>K2>K1). In other words, the more on the downstream side of the conveyance direction, the air curtain along the arrangement direction is harder to be formed. Therefore, the perturbation of the air flow is hard to become large.

### Fourth Embodiment

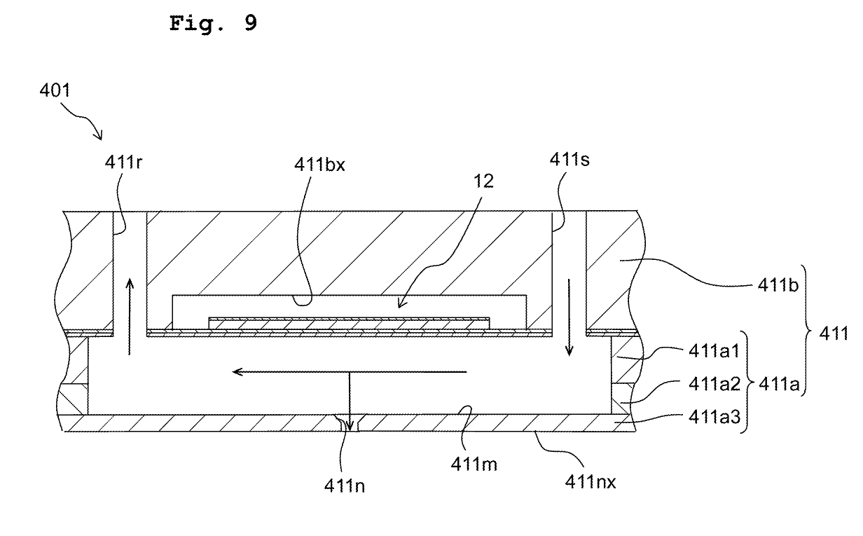

Next, for a head 401 according to a fourth embodiment of the present teaching, points that differ from the head 1 according to the first embodiment will be described below by referring to FIG. 9. An arrangement of pressure chambers, nozzles, a supply channel, and a return channel in the head 401 differs from that of the head 1.

In the present embodiment, a channel substrate 411 includes a channel plate 411a in which a plurality of pressure chambers 411m and a plurality of nozzles 411n are formed, and a reservoir plate 411b in which a supply channel 411s and a return channel 411r are formed.

A recess 411bx is formed in a lower surface of the reservoir plate 411b. The reservoir plate 411b is adhered to an upper surface of the channel plate 411a such that the actuator 12 is arranged in the recess 411bx.

The channel plate 411a includes three plates 411a1, 411a2, and 411a3 (hereinafter, plates 411a1 to 411a3), and the three plates are adhered to one another. An upper portion of the pressure chamber 411m is formed to be through in the plate 411a1. A lower portion of the pressure chamber 411m is formed to be through in the plate 411a2. The nozzle 411n is formed to be through in the plate 411a3. A lower surface of the plate 411a3 (a lower surface of the channel plate 411a) is a nozzle surface 411nx in which the plurality of nozzles 411n open.

The supply channel 411s and the return channel 411r are positioned at an upper side of each pressure chamber 11m, and partially overlaps with each pressure chamber 11m when viewed from a perpendicular (vertical) direction. The supply channel 411s supplies an ink from the upper side to each pressure chamber 11m. The ink supplied to each pressure chamber 11m moves horizontally, and some of the ink is jetted from the nozzle 11n while the remaining ink inflows into to the return channel 411r from the upper side, and is returned to the storage chamber 14x (refer to FIG. 4).

The preferred embodiments of the present teaching and, modified embodiments of the preferred embodiments have been described above. However, the present teaching is not restricted to the abovementioned embodiments and modified embodiments, and various design modifications are possible within the scope of the patent claims.

### OTHER MODIFIED EXAMPLES

The orthogonal direction is not restricted to be parallel to the conveyance direction, and may intersect the conveyance direction for example.

A position of a nozzle other than nozzles positioned at end in the arrangement direction, of the plurality of nozzles belonging to one pressure chamber row, may not differ from a position in the orthogonal direction of nozzles adjacent on both sides in the arrangement direction. In other words, the nozzle may be at a position in the orthogonal direction different from a position of one of the adjacent nozzles, and may be at a position in the orthogonal direction same as a position of the other adjacent nozzle.

A distance in the orthogonal direction, between two mutually most separated nozzles in the orthogonal direction, in the plurality of nozzles belonging to one pressure chamber row, may be less than a distance in the orthogonal direction from that nozzle up to an end portion near the nozzle in the orthogonal direction out of two ends in the orthogonal direction of the active portion facing the pressure chamber communicating with that nozzle, for each of the two nozzles.

A distance in the orthogonal direction from one nozzle up to another nozzle that is adjacent in the arrangement direction, in the plurality of nozzles belonging to one pressure chamber row may not be equal to the minimum distance in the orthogonal direction from the plurality of nozzles belonging to one pressure chamber row up to the plurality of nozzles belonging to another pressure chamber row that is adjacent in the orthogonal direction to that pressure chamber row, and may be more than the minimum distance, or may be less than the minimum distance.

A distance in the orthogonal direction from one nozzle up to another nozzle that is adjacent in the arrangement direction, of the plurality of nozzles belonging to one pressure chamber row may be less than a distance in the orthogonal direction between the plurality of pressure chambers forming the one pressure chamber row and the plurality of pressure chambers forming another pressure chamber row that is adjacent in the orthogonal direction to that pressure chamber row, or may be less than a distance in the orthogonal direction between the plurality of active portions belonging to one pressure chamber row and the plurality of active portions belonging to another pressure chamber row that is adjacent in the orthogonal direction to that pressure chamber row, or may not be an even multiple of the distance corresponding to the maximum resolution in the orthogonal direction.

When there is a plurality of patterns of a distance in the orthogonal direction from the supply channel of the plurality of nozzles corresponding to the plurality of dots lined up in the arrangement direction, the plurality of nozzles corresponding to the plurality of dots lined up in the arrangement direction may have been arranged in an arbitrary pattern.

Each nozzle may not be arranged in the pressure chamber area and/or in the active portion area.

The plurality of nozzles belonging to one pressure chamber row may form four or more than four nozzle rows. For example, the number of nozzle rows belonging to a pressure chamber row including the pressure chamber may be let to be large in proportion to the length in the orthogonal direction of each pressure chamber.

The plurality of nozzles belonging to all of the plurality of pressure chamber rows may not be arranged at an equal distance in the orthogonal direction.

The number of the pressure chamber rows is not restricted to four, and may be one or more than one.

A distance in the orthogonal direction between the plurality of pressure chambers forming one pressure chamber row and the plurality of pressure chambers forming another pressure chamber row adjacent in the orthogonal direction to that pressure chamber row may not be longer than the length in the orthogonal direction of one active portion.

Positions in the orthogonal direction of the plurality of pressure chambers forming one pressure chamber row may differ. In other words, pressure chambers having mutually different position in the orthogonal direction may exist in one pressure chamber row.

A longitudinal direction of each pressure chamber is not restricted to the orthogonal direction. The longitudinal direction of each pressure chamber forming one pressure chamber row and the longitudinal direction of each pressure chamber forming another pressure chamber adjacent in the orthogonal direction to that pressure chamber row, may be mutually different. A length in the longitudinal direction of each pressure chamber forming one pressure chamber row, and a length in the longitudinal direction of each pressure chamber forming another pressure chamber row adjacent in the orthogonal direction to that pressure chamber row, may differ mutually.

The supply channel may not be arranged between two pressure chamber rows that are mutually adjacent in the orthogonal direction. For example, in a case in which there are two pressure chamber rows that are mutually adjacent in the orthogonal direction, a return channel may be arranged between the two pressure chamber rows, and the supply channel may be arranged at an outer side in the orthogonal direction, of the two pressure chamber rows.

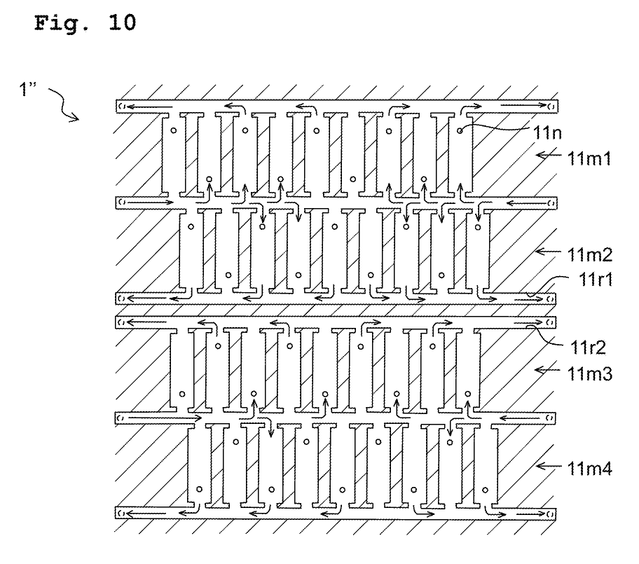

The supply channel and/or the return channel are/is not restricted to be in common to the two pressure chamber rows that are mutually adjacent in the orthogonal direction. In other words, the supply channel and/or the return channel may be provided for each pressure chamber row. For example, instead of providing the supply channel 11s that is in common to these pressure chamber rows 11m1 and 11m2, between the pressure chamber row 11m1 and the pressure chamber row 11m2 in FIG. 2, a supply channel that supplies an ink to the pressure chamber row 11m1 and a supply channel that supplies an ink to the pressure chamber 11m2 may be provided. Similarly, as in a head 1″ according to a modified embodiment in FIG. 10, a return channel 11r1 which returns an ink from the pressure chamber row 11m2 to the storage chamber 14x and a return channel 11r2 which returns an ink from the pressure chamber row 11m3 to the storage chamber 14x may be provided between the pressure chamber row 11m2 and the pressure chamber row 11m3. According to the modified embodiment in FIG. 10, it is possible to supply inks of mutually different types (such as mutually different colors) to the pressure chamber rows 11m1 and 11m2 and the pressure chamber rows 11m3 and 11m4, and to make jet inks of mutually different types from the nozzles 11n belonging to the pressure chamber rows 11m1 and 11m2, and the pressure chamber rows 11m3 and 11m4 respectively.

A relationship in a vertical direction of the supply channel and/or the return channel and each pressure chamber is not restricted to the relationship exemplified in the embodiments described above, and can be changed arbitrarily. For example, the supply channel and the return channel may be positioned at a lower side of each pressure chamber, and may supply an ink to each pressure chamber from a lower side.

The return channel may not be formed in the channel substrate (in other words, an arrangement is not restricted to an arrangement of circulating an ink between the storage chamber and each pressure chamber). The channel substrate is not restricted to be formed by adhering a plurality of members to one another, and may be formed by a single member.

A supply port through which a liquid is supplied from the storage chamber may be formed at one end in a longitudinal direction in one channel that supplies the liquid to the plurality of pressure chambers, and a discharge port through which the liquid is discharged to the storage chamber may be formed at the other end in the longitudinal direction in one channel that supplies the liquid to the plurality of pressure chambers.

The actuator is not restricted to be of the piezoelectric type in which a piezoelectric element has been used as in the embodiments described above, and may be of another type (such as a thermal type in which a heater element is used and an electrostatic type in which an electrostatic element is used).

The liquid jetting head is not restricted to be of the line type, and is also applicable to a serial type (a type of jetting a liquid on to a recording medium that is conveyed along the conveyance direction parallel to the arrangement direction, while making the head scan along the orthogonal direction). Moreover, the liquid jetting apparatus is not restricted to be equipped with a head unit which includes a plurality of liquid jetting heads, and may include a single liquid jetting head. The liquid to be jetted by the liquid jetting head is not restricted to an ink, and may be an arbitrary liquid (such as a process liquid (processing solution, treatment liquid) which coagulates (aggregates) or precipitates constituents in an ink). The recording medium is not restricted to paper, and may be an arbitrary medium on which a recording is possible (such as a cloth). The present teaching is not restricted to a printer, and is also applicable to a facsimile, a copy machine, and a multifunction device.

What is claimed is:

1. A liquid jetting head, comprising:
a channel substrate having a nozzle surface in which nozzles are open, the channel substrate being formed with pressure chambers communicating with the nozzles respectively; and
an actuator covering the pressure chambers,
wherein the pressure chambers include first pressure chambers arranged in an arrangement direction to form a first pressure chamber row in the channel substrate,
each of the first pressure chambers has a first end on one side in an orthogonal direction and a second end on the other side in the orthogonal direction, the orthogonal direction being parallel to the nozzle surface and orthogonal to the arrangement direction,
the nozzles include first nozzles communicating with the first pressure chambers respectively,
any two first nozzles, which are included in the first nozzles and adjacent to each other in the arrangement direction, are arranged at different positions in the channel substrate with respect to the orthogonal direction and different in a first distance, the first distance being a distance in the orthogonal direction between each first nozzle and the first end of each first pressure chamber communicating with the first nozzle,
the first nozzles include farthest two first nozzles that are separated from each other farthest with respect to the orthogonal direction, and
a second distance in the orthogonal direction between the farthest two first nozzles is not less than a third distance, the third distance being a distance between each of the farthest two first nozzles and a nearest end of each first pressure chamber communicating with the first nozzle, the nearest end of the first pressure chamber being one of the first end and the second end which is nearer to the first nozzle in the orthogonal direction.

2. The liquid jetting head according to claim 1, wherein the first pressure chambers are arranged at positions which are the same with respect to the orthogonal direction.

3. The liquid jetting head according to claim 2, wherein each of the first nozzles is arranged in a pressure chamber area formed by projecting the first pressure chamber communicating with the first nozzle on the nozzle surface from a direction orthogonal to the nozzle surface.

4. The liquid jetting head according to claim 3,
wherein the actuator includes active portions facing the pressure chambers respectively, in the direction orthogonal to the nozzle surface,
each of the active portions has two ends in the orthogonal direction, and
the second distance is not less than a fourth distance, the fourth distance being a distance between each of the farthest two first nozzles and a nearest end of an active portion facing the first pressure chamber which communicates with the first nozzle, the nearest end of the active portion being one of the two ends which is nearer to the first nozzle in the orthogonal direction.

5. The liquid jetting head according to claim 4, wherein each of the first nozzles is arranged in an active portion area formed by projecting the active portion facing the first pressure chamber which communicates with the first nozzle on the nozzle surface from the direction orthogonal to the nozzle surface.

6. The liquid jetting head according to claim 1, wherein each of the first nozzles, excluding the first nozzles positioned at both ends in the arrangement direction, is arranged at a position which is different from positions of the first nozzles arranged to be adjacent to the first nozzle on both sides in the arrangement direction of the first nozzles, with respect to the orthogonal direction.

7. The liquid jetting head according to claim 6,
wherein the pressure chambers further include second pressure chambers which form a second pressure chamber row, the second pressure chamber row being adjacent to the first pressure chamber row in the orthogonal direction in the channel substrate,
the nozzles further include second nozzles communicating with the second pressure chambers respectively, and
a fifth distance in the orthogonal direction between two first nozzles that are adjacent in the arrangement direction is not less than a sixth distance, the sixth distance being the minimum distance in the orthogonal direction between the first nozzles and the second nozzles.

8. The liquid jetting head according to claim 7, wherein the fifth distance is equal to the sixth distance.

9. The liquid jetting head according to claim 8,
wherein the pressure chambers form pressure chamber rows arranged in the orthogonal direction in the channel substrate,
the pressure chamber rows include the first pressure chamber row and the second pressure chamber row, each of the nozzles belongs to one of the pressure chamber rows, and
the nozzles are arranged at an equal spacing distance with respect to the orthogonal direction.

10. The liquid jetting head according to claim 7,
wherein the orthogonal direction is parallel to a conveyance direction in which a recording medium is conveyed,
the second pressure chamber row is formed on a downstream side in the conveyance direction of the first pressure chamber row, and
a seventh distance in the orthogonal direction between two second nozzles that are adjacent in the arrangement direction is more than the fifth distance.

11. The liquid jetting head according to claim 7, wherein the fifth distance is not less than a distance in the orthogonal direction between the first pressure chambers and the second pressure chambers.

12. The liquid jetting head according to claim 7,
wherein the actuator includes active portions facing the pressure chambers respectively, in a direction orthogonal to the nozzle surface,
the active portions include first active portions facing the first pressure chambers respectively, and second active portions facing the second pressure chambers respectively, and
the fifth distance is not less than a distance in the orthogonal direction between the first active portions and the second active portions.

13. The liquid jetting head according to claim 12, wherein a distance in the orthogonal direction between the first pressure chambers and the second pressure chambers is less than a length of each of the active portions in the orthogonal direction.

14. The liquid jetting head according to claim 1,
wherein the first nozzles form two nozzle rows arranged in the orthogonal direction, and
each of the two nozzle rows is extended in the arrangement direction.

15. The liquid jetting head according to claim 1,
wherein the first nozzles form three nozzle rows arranged in the orthogonal direction, and
each of the three nozzle rows is extended in the arrangement direction.

16. The liquid jetting head according to claim 1, wherein the channel substrate is formed with: a supply channel through which liquid is supplied to each of the pressure chambers from a storage chamber storing the liquid; and a return channel through which the liquid is returned to the storage chamber from the pressure chambers.

17. The liquid jetting head according to claim 7,
wherein the pressure chambers form pressure chamber rows arranged in the orthogonal direction, in the channel substrate,
the pressure chamber rows include the first pressure chamber row and the second pressure chamber row,
the channel substrate is formed with at least one supply channel through which liquid is supplied to each of the pressure chambers from a storage chamber storing the liquid,
each of the nozzles has a supply distance in the orthogonal direction from the nozzle to the at least one supply channel which supplies the liquid to the pressure chamber communicating with the nozzle, and
the nozzles are arranged such that the number of nozzles having the same supply distance and being consecutive in the arrangement direction is the minimum.

18. The liquid jetting head according to claim 17, wherein the nozzles are arranged such that nozzles having the same supply distance are not consecutive for 84 μm or more in the arrangement direction.

19. The liquid jetting head according to claim 18, wherein the nozzles are arranged such that nozzles having the same supply distance are not consecutive in the arrangement direction.

20. The liquid jetting head according to claim 17, wherein the fifth distance is an even multiple of a distance corresponding to the maximum resolution in the orthogonal direction.
